(19) United States
(12) Patent Application Publication
(10) Pub. No.: US 2014/0247034 A1
(43) Pub. Date: Sep. 4, 2014

(54) LOW SUPPLY VOLTAGE BANDGAP REFERENCE CIRCUIT AND METHOD

(71) Applicant: Hong Kong Applied Science and Technology Research Institute Company Limited, (US)

(72) Inventors: Chi Fung Lok, Hong Kong (HK); Le Feng Shen, Shenzhen (CN)

(73) Assignee: Hong Kong Applied Science and Technology Research Institute Company Limited, Hong Kong (HK)

(21) Appl. No.: 13/783,423

(22) Filed: Mar. 4, 2013

(51) Int. Cl. G05F 3/02

(52) U.S. Cl. CPC G05F 3/02
USPC 323/313

(57) ABSTRACT

A circuit and method for a bandgap voltage reference operating at 1 volt or below is disclosed, wherein the operational amplifier (A₁) drives resistors (R₂, R₃) only so that both the flicker noise contribution and the process sensitivity due to the conventional metal oxide semiconductor (MOS) devices used as a current mirror within the proportional-to-absolute-temperature (PTAT) loop are eliminated. Two symmetric resistive divider pairs formed by (R_{1A}/R_{1B}, R_{2A}/R₂B) are inserted to scale down both the base-emitter voltages (V_{EB1}, V_{EB2}) of bipolar transistors (Q₁, Q₂) and the PTAT current (I_{PTAT}) so that an output reference voltage (V_{REF}) becomes scalable. Proper bias currents through transistors (M₃, M₄), which are used to bias (Q₁, Q₂) and (R_{1A}/R_{1B}, R_{2A}/R_{2B}) respectively, are produced by an additional V-I converter (319) using V_{REF} itself, resulting in a final process, voltage and temperature (PVT) insensitive output reference voltage.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to bandgap voltage reference circuit that provides temperature independent reference voltage, more particularly, to low supply voltage bandgap reference circuit and method.

### BACKGROUND

A bandgap voltage reference circuit is used to generate a temperature independent reference voltage and is widely used in analog, digital, mixed-signal and RF circuits. Referring to the prior art in FIG. 1, it is referred to as “Voltage Mode” bandgap voltage reference because the temperature compensation is performed in voltage domain. It is well-known that the typical temperature independent bandgap voltage reference is around 1.25V at room temperature (e.g. 298K), which approximates the theoretical 1.22 eV bandgap of silicon at absolute temperature (i.e. 0K). Since the typical output voltage of such circuit is fixed around 1.25V over the temperature range of interest, the minimum supply voltage to such circuit, which is based on traditional standard CMOS technology, has to be at least 1.4V for proper function, resulting in the fundamental limitation on bandgap voltage reference operating at a low supply voltage (e.g. 1V). In order to be compatible with the state-of-the-art advanced CMOS process that the typical supply voltage is 1.2V or below (e.g. 130 nm or below), recent developments in the prior arts have proposed various low supply voltage bandgap reference solutions. Referring to the prior art shown in FIG. 2, it is referred to as “Current Mode” bandgap voltage reference because the temperature compensation is first performed in current domain and subsequently changed to voltage quantity. With this implementation, the supply voltage is no longer restricted by the theoretical silicon's bandgap voltage of 1.25V and therefore it allows the bandgap reference operating at a low supply voltage (e.g. 1V) and can be fully compatible with standard advance CMOS process. Since then, a variety of “Current Mode” bandgap voltage reference circuits are derived from this prior art. However, the implementation of “Current Mode” bandgap voltage reference must require MOS devices used as a current mirror in order to function properly. Those MOS devices contribute substantial flicker noise at the reference output due to common source configuration especially when the ground current is very small for low power consumption. Furthermore, the matching properties of active MOS devices are usually worse than those of passive resistors because MOS devices suffer from the variations of both threshold voltage and current gain whereas resistors suffer from the variation of resistance only. In other words, they enhance the process sensitivity of the reference output unfortunately. In summary, these solutions have limitations such as having high flicker noise and process sensitivity. As such, the primary objective of the present invention is to implement a low supply voltage bandgap voltage reference with lower flicker noise and less process sensitive.

### SUMMARY OF THE INVENTION

It is an objective of the presently claimed invention to provide a circuit and method for generating a temperature independent bandgap voltage reference with the advantages of having both “Voltage Mode” and “Current Mode”, low flicker noise, less process sensitive, and operable under low supply voltage. An embodiment of the circuit comprises a voltage-to-current converter circuit configured to generate a first reference current and a second reference current; a first differential voltage divider configured to scale down a first base-emitter voltage of a first bipolar junction transistor biased by the first reference current to generate a first scaled base-emitter voltage; a second differential voltage divider configured to scale down a second base-emitter voltage of a second bipolar junction transistor biased by the second reference current to generate a second scaled base-emitter voltage; and a bandgap voltage reference circuit configured to generate a reference voltage by using the first scaled base-emitter voltage and the second scaled base-emitter voltage. An embodiment of the method for generating a temperature independent bandgap voltage reference comprises scaling down the base-emitter voltages of bipolar junction transistors biased by reference currents; applying the scaled base-emitter voltages to a proportional-to-absolute-temperature (PTAT) loop for generating a scaled PTAT current; generating a temperature independent reference voltage from the scaled PTAT current; generating feedback reference currents until all bipolar junction transistors are properly biased over the operating temperature range, supply voltage range and process corners; and generating a process, voltage, and temperature (PVT) insensitive reference voltage from the scaled PTAT current.

### BRIEF DESCRIPTION OF THE DRAWINGS:

Embodiments of the invention are described in more detail hereinafter with reference to the drawings, in which

FIG. 1 is a schematic depiction of a prior art “Voltage Mode” bandgap voltage reference circuit;

FIG. 2 is a schematic depiction of a prior art “Current Mode” bandgap voltage reference circuit;

FIG. 3 is a schematic depiction of a circuit for generating a bandgap voltage reference according to an embodiment of the present invention;

FIG. 4 illustrates the functions of base-emitter voltage and input common mode voltage of the amplifier within bandgap reference core over the temperature according to an embodiment of the present invention;

FIG. 5 illustrates the function of output reference voltage over the supply voltage at two extreme temperature conditions according to an embodiment of the present invention;

FIG. 6 illustrates the function of output reference voltage over the temperature according to an embodiment of the present invention;

FIG. 7 illustrates the noise function of output reference voltage according to the prior art (convention) of FIG. 2 in comparison with the invention according to an embodiment of the present invention; and

FIG. 8 is a flow chart depiction of a process of generating a bandgap voltage reference according to an embodiment of the present invention.

### DETAILED DESCRIPTION:

In the following description, circuits for providing bandgap voltage references and associated current references and the like are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

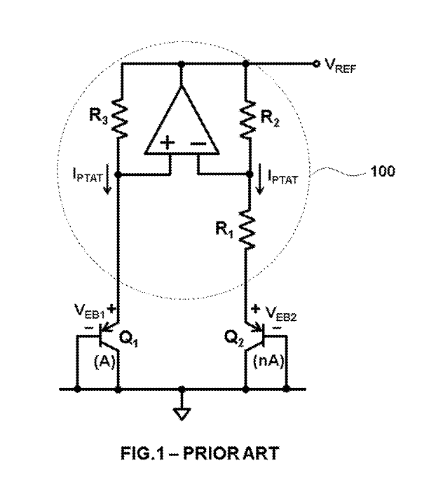

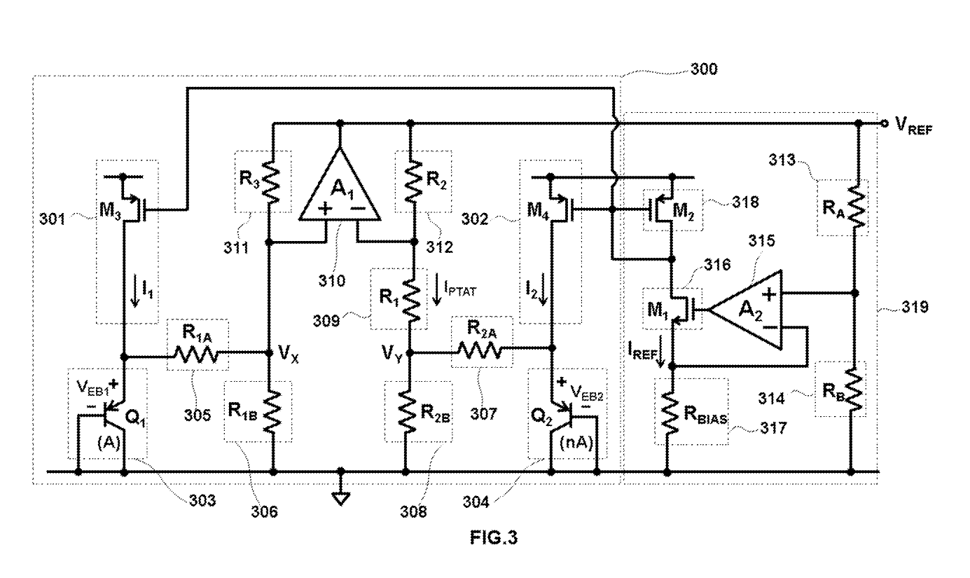

FIG. 3 shows a circuit diagram of an embodiment of the circuit for generating a temperature independent reference voltage in accordance to the present invention. In this circuit, constant supply currents I₁ (301) and I₂ (302) are fed to the bipolar junction transistors Qᵢ (303) and Q₂ (304) respectively to provide the corresponding base-emitter voltages V_{EB1} and V_{EB2}. V_{EB1} and V_{EB2} are then scaled down by a first differential voltage divider comprising resistors R_{1A} (305) and R_{1B} (306), and a second differential voltage divider comprising resistors R_{2A} (307) and R_{2B} (308) to arrive at V_{X} and V_{Y} respectively, which their magnitudes are smaller than the corresponding V_{EB1} and V_{EB2} as can be seen in the subsequent description. In contrast to the prior art shown in FIG. 1, both V_{X} and V_{Y} replace V_{EB1} and V_{EB2}, and are applied to a proportional-to-absolute-temperature (PTAT) loop for generating a scaled PTAT current I_{PTAT} instead, wherein the PTAT loop comprises an operational amplifier A₁ (310) and three resistors R₁ (309), R₂ (312) and R₃ (311). This scaled PTAT current I_{PTAT} flows equally across R₂ and R₃ as long as the open loop gain of the operational amplifier A₁ (310) is high enough (e.g. 80 dB). It is instructive to note that this core feedback loop comprises no active MOS devices in the present invention. Rather, in the present invention, the temperature independent reference voltage V_{REF} is generated at the output of the operational amplifier A₁ (310) directly. The portion of the circuit (300) that forms the main bandgap reference: (i) enables low supply voltage operation; (ii) removes the active MOS devices for current copying in the PTAT loop that were otherwise present at “Current Mode” bandgap reference counterpart as explained; and (iii) reduces the sensitivity to fluctuation in the input common mode voltage to the operational amplifier A₁. Therefore, the supply voltage can be resistively scaled down to 1.2V or below according to the present invention.

The temperature independent reference voltage V_{REF} is defined by:

$${V}_{REF} = \frac{{R}_{1 B}}{{R}_{1 A} + {R}_{1 B}} \{ {V}_{EB 1} + Δ {V}_{EB} [ \frac{( {R}_{1 A} // {R}_{1 B} ) + {R}_{2}}{{R}_{1}} ] \} , \\ where$$

$$Δ {V}_{EB} = {V}_{EB 1} - {V}_{EB 2}$$

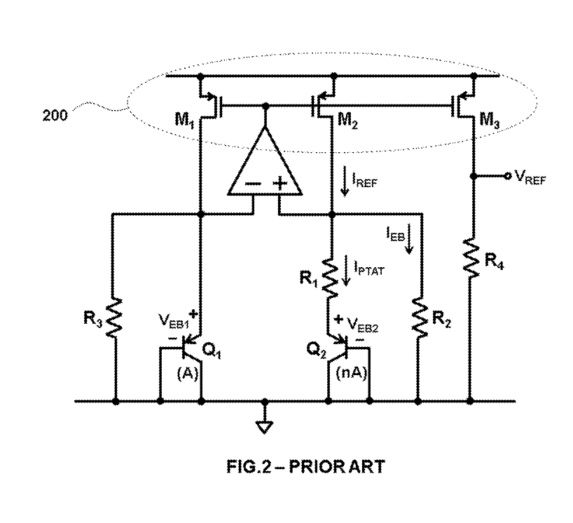

Referring to FIG. 3, the present invention does not have any active MOS device in the core feedback loop. The PTAT loop entails the advantages of having lower flicker noise performance, less strict matching requirement, and constant feedback factors. First, according to the present invention, the fundamental flicker noise performance is restricted by the operational amplifier A₁ only. This is in contrast to that in some of the prior arts, such as the one shown in FIG. 2, which is restricted by both the operational amplifier and the MOS current mirrors. It is important to note that the typical flicker noise is at the frequency range of 1 Hz-1 kHz where the flicker noise is not easily removed by implementing an on-chip low-pass filter due to the requirement of the very large time constant. In other words, an expensive off-chip low-pass filter is needed if one desires low flicker noise performance particularly for some applications without the appropriate clock signal available for chopper stabilization. Second, according to the present invention, the matching requirement relies on the passive components in contrast to both the active and the passive components in some of the prior arts, such as the one shown in FIG. 2. As such, the matching requirement of the present invention is much relaxed. Third, according to the present invention, both the feedback factors and noise/offset multipliers are defined by the resistive ratios, which allow a better control in mass production over process, voltage, and temperature (PVT) changes in contrast to non-ratiometric in some of the prior arts using the “Current Mode” technique. In addition, the effect of the operational amplifier A₁ due to offset-drift over temperature is reduced as the input common mode voltage change is reduced in contrast to the base-emitter voltage change in some of the prior arts, such as the ones shown in FIG. 1 and FIG. 2. As a result, the present invention potentially extends the operating temperature range of the bandgap voltage reference circuit to as low as −50° C. with a bipolar junction transistors' base-emitter voltage of 0.85V under a minimum V_{DD} of 1.0V, and becomes favorable in view of production.

Referring to FIG. 3, FIG. 3 also shows a circuit diagram of an embodiment of a voltage-current (V-I) converter circuit (319) for providing appropriate feedback reference currents (I₁, I₂) to the circuit for generating the overall PVT independent reference voltage according to the present invention. The V-I converter circuit comprises an operational amplifier A₂ (315) where the temperature independent reference voltage V_{REF} is supplied to its non-inverting input through a voltage divider comprising resistors R_{A} (313) and R_{B} (314). A biasing resistor R_{BIAS} (317) is placed between the ground and the source terminal of MOS transistor M₁ (316). The output of the operational amplifier A₂ (315) drives the gate of M₁(316). The drain terminal of M₁ (316) is connected to the diode-connected MOS transistor M₂ (318) serving as a current mirror circuit for generating the feedback reference current I_{REF}. The loop comprises the operational amplifier A₂ (315) and the MOS transistor M₁ (316) is in negative feedback. The feedback reference current I_{REF} generated can eventually provide the supply currents I₁ (301) and I₂ (302) via MOS transistors M₃ and M₄ to complete an overall bandgap reference. It is important to note that both the offset voltage of the operational amplifier A₂ (315) and the supply current mismatches across M₃ and M₄ are suppressed by a current ratio within the natural logarithmic term. As a result, the matching requirement is still less stringent that those current mirrors used in some of the prior arts, such as the one shown in FIG. 2.

Referring to FIG. 3, if the open loop gain of operational amplifier A₁>>1, the feedback reference current I_{REF} is defined by:

$${I}_{REF} = \frac{{R}_{B}}{{R}_{A} + {R}_{B}} \frac{{V}_{REF}}{{R}_{BIAS}}$$

Still referring to FIG. 3, the definition of V_{REF} can be mathematically derived by the following:

If the open loop gain of operational amplifier A₁>>1, then:

$${I}_{PTAT} = \frac{{V}_{X} - {V}_{Y}}{{R}_{1}} \qquad ( 1 )$$

By nodal analysis at V_{X} and V_{Y}:

$$\begin{matrix}\frac{{V}_{EB 1} - {V}_{X}}{{R}_{1 A}} + {I}_{PTAT} = \frac{{V}_{X}}{{R}_{1 B}} ⇔ ∴ {V}_{X} = \frac{{R}_{1 B}}{{R}_{1 A} + {R}_{1 B}} ( {V}_{EB 1} + {I}_{PTAT} {R}_{1 A} ) & ( 2 ) \\ \frac{{V}_{EB 2} - {V}_{Y}}{{R}_{2 A}} + {I}_{PTAT} = \frac{{V}_{Y}}{{R}_{2 B}} ⇔ ∴ {V}_{Y} = \frac{{R}_{2 B}}{{R}_{2 A} + {R}_{2 B}} ( {V}_{EB 2} + {I}_{PTAT} {R}_{2 A} ) & ( 3 )\end{matrix}$$

Substitute (2) and (3) into (1):

$$∴ {I}_{PTAT} = α \frac{{V}_{EB 1} - {V}_{EB 2}}{{R}_{1}} = \frac{α Δ {V}_{EB}}{{R}_{1}} \qquad ( 4 )$$

Emitter-base current of Q₁ is defined by:

$${I}_{EB 1} = {I}_{REF} + {I}_{PTAT} - \frac{{V}_{X}}{{R}_{2 B}} \qquad ( 5 )$$

Similarly, emitter-base current of Q₂ is defined by:

$${I}_{EB 2} = {I}_{REF} + {I}_{PTAT} - \frac{{V}_{Y}}{{R}_{2 B}} \qquad ( 6 )$$

Assume Q₁ and Q₂ have identical current gain, then:

$$Δ {V}_{EB} = {V}_{T} [ 𝓁n ( \frac{{I}_{S 2}}{{I}_{S 1}} ) + 𝓁n ( \frac{{I}_{C 1}}{{I}_{C 2}} ) ] = {V}_{T} [ 𝓁n ( \frac{{I}_{S 2}}{{I}_{S 1}} ) + 𝓁n ( \frac{{I}_{EB 1}}{{I}_{EB 2}} ) ] \qquad ( 7 )$$

Consider:

$$𝓁n ( \frac{{I}_{EB 1}}{{I}_{EB 2}} ) = 𝓁n ( \frac{{I}_{REF} + α {I}_{PTAT} - \frac{α {V}_{EB 1}}{{R}_{1 B}}}{{I}_{REF} + α {I}_{PTAT} - \frac{α {V}_{EB 2}}{{R}_{2 B}}} ) = 𝓁n ( 1 - \frac{\frac{α Δ {V}_{EB}}{{I}_{0} {R}_{1 B}}}{1 - \frac{α Δ {V}_{EB2}}{{I}_{0} {R}_{2 B}}} ) \approx - \frac{α Δ {V}_{EB}}{{I}_{0} {R}_{1 B} - α {V}_{EB 2}} \qquad ( 8 )$$

Substitute (8) into (7):

$$Δ {V}_{EB} \approx {V}_{T} [ 𝓁 n ( n ) - \frac{α Δ {V}_{EB}}{{I}_{0} {R}_{1 B} - α {V}_{EB 2}} ] \qquad ( 9 )$$

Rearranging (9):

$$Δ {V}_{EB} \approx \frac{{V}_{T} 𝓁n ( n )}{1 + \frac{α {V}_{T}}{{R}_{1 B} ( {I}_{REF} + α {I}_{PTAT} ) - α {V}_{EB 2}}} \qquad ( 10 )$$

Consider I_{PTAT}:

$${I}_{PTAT} \approx {\frac{α {V}_{T} 𝓁n ( n )}{{R}_{1}} [ 1 + \frac{α {V}_{T}}{{R}_{1 B} ( {I}_{REF} + α {I}_{PTAT} ) - α {V}_{EB 2}} ]}^{- 1} \qquad ( 11 )$$

Since (10) and (11) are recursive equations, simplification is necessary. Let:

$$\begin{matrix}{I}_{PTAT 0} = \frac{α {V}_{T} 𝓁n ( n )}{{R}_{1}} & ( 12 ) \\ {I}_{REF 0} = \frac{{R}_{B}}{{R}_{A} + {R}_{B}} \frac{{V}_{REF 0}}{{R}_{BIAS}} & ( 13 )\end{matrix}$$

Then I_{PTAT} can be estimated to be:

$${I}_{PTAT} \approx {I}_{PTAT 0} [ 1 - \frac{α {V}_{T}}{{R}_{1 B} ( {I}_{REF 0} + α {I}_{PTAT 0} ) - α {V}_{EB 2}} ] \qquad ( 14 )$$

(14) implies that:

$$Δ {V}_{EB} \approx {V}_{T} 𝓁n ( n ) ( 1 - \frac{α {V}_{T}}{{R}_{1 B} ( {I}_{REF 0} + α {I}_{PTAT 0} ) - α {V}_{EB 2}} ) \qquad ( 15 )$$

Therefore, the temperature independent reference voltage V_{REF} is:

$${V}_{REF} = α ( {V}_{EB 1} + Δ {V}_{EB} \frac{{R}_{1 A} // {R}_{1 B} + {R}_{2}}{{R}_{1}} ) \qquad ( 16 )$$

It is observed that equation (15) contains a first order temperature dependent term and a higher order temperature dependent term that is supposedly negligible to a first-order approximation. Hence, the conventional expression still holds in the present invention.

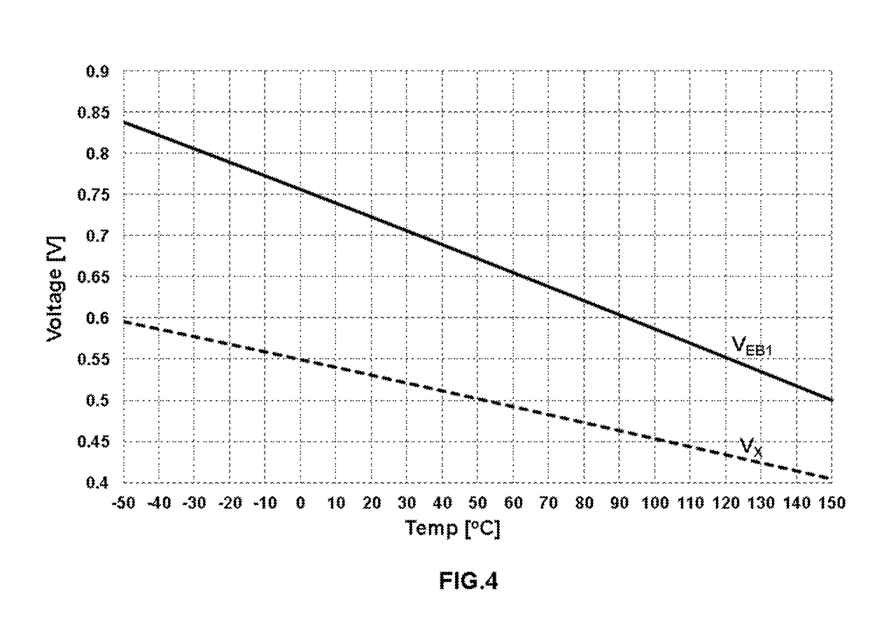

Referring to FIG. 4, the functions of V_{EB1} and V_{X} over temperature are depicted according to an illustrative embodiment of the present invention. As mentioned in an embodiment shown in FIG. 3, V_{EB1} is as high as 0.85V at −50° C., V_{X} is always smaller than V_{EB1} over the entire temperature range of interest (i.e. −50° C. to 150° C.), and hence the change of V_{X} is smaller than that of V_{EB1} resulting in extending the operating temperature range and reducing the offset drift of the operational amplifier A₁ in the present invention.

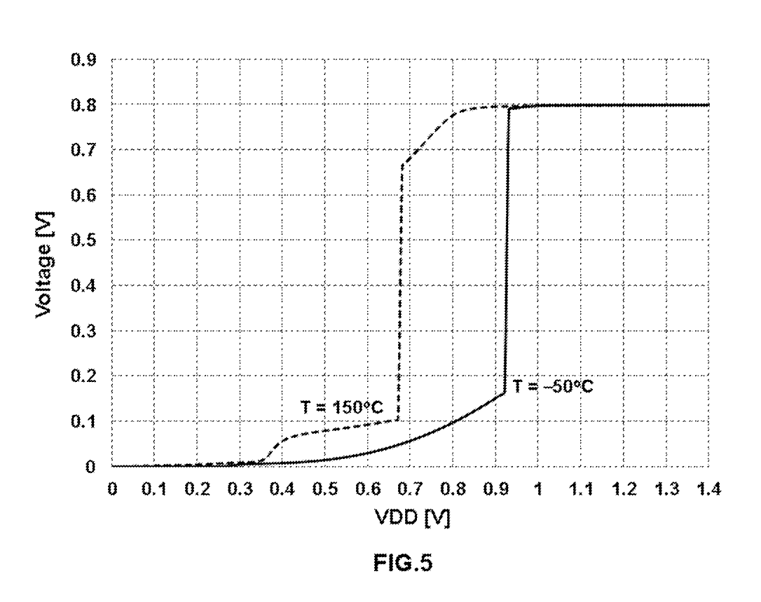

Referring to FIG. 5, the functions of V_{REF} over supply voltage at −50° C. and 150° C. are depicted according to an illustrative embodiment of the present invention shown in FIG. 3. Observe that the limitation on the minimum achievable supply voltage is at −50° C. because Q₁ is turned on as long as supply voltage attains 0.85V or higher. The two curves of the functions of V_{REF} over supply voltage at −50° C. and 150° C. converge at the supply voltage of 1V for the output reference voltage of 0.8V in an illustrative embodiment.

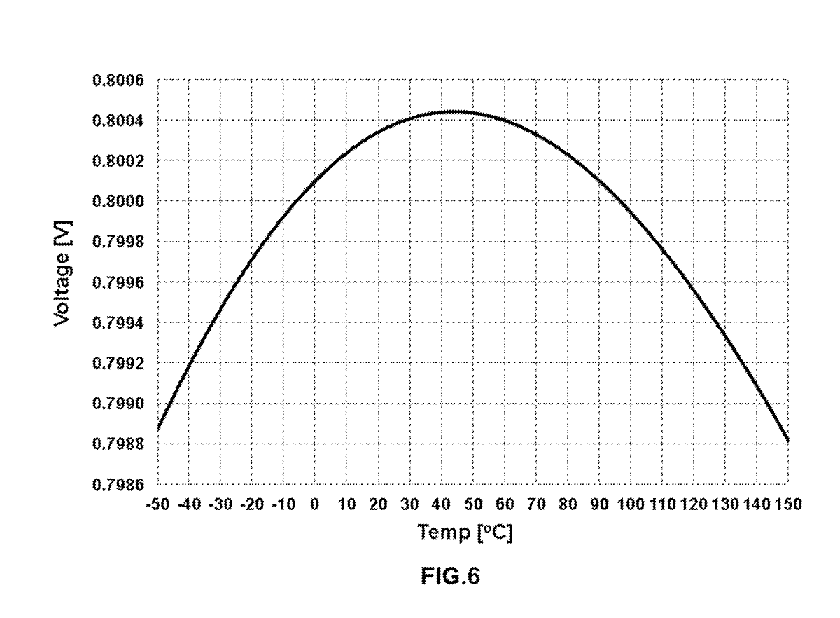

Referring to FIG. 6, the function of V_{REF} over temperature is depicted according to an illustrative embodiment of the present invention shown in FIG. 3. For a first-order temperature compensation, the curvature shape of the output reference remains.

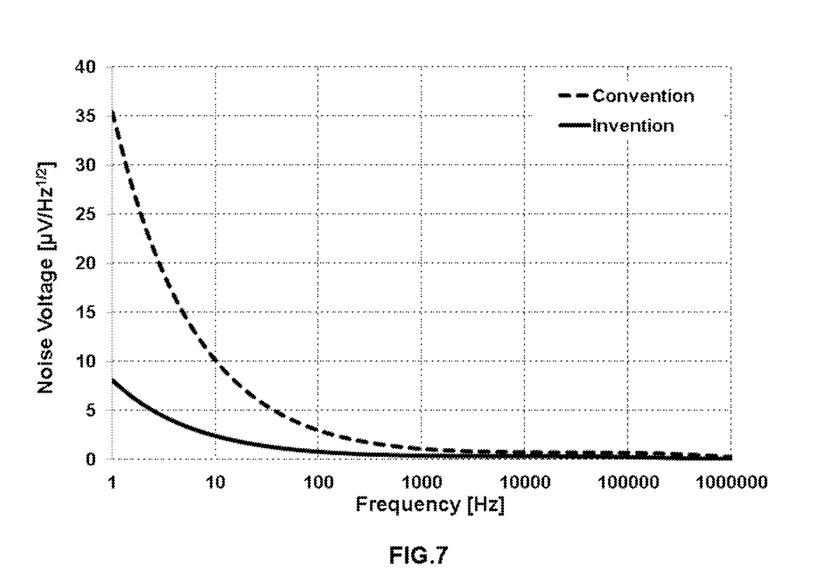

Referring to FIG. 7, the noise functions of V_{REF} in the convention and the invention are depicted according to the prior art shown in FIG. 2 and an illustrative embodiment of the present invention shown in FIG. 3, respectively. Because of the absence of any active MOS device in the PTAT loop in an embodiment of the present invention shown in FIG. 3, the flicker noise performance is reduced significantly from 1 Hz to 1 kHz whereas their high frequency noise functions converges that can be removed by a simple on-chip low-pass filter.

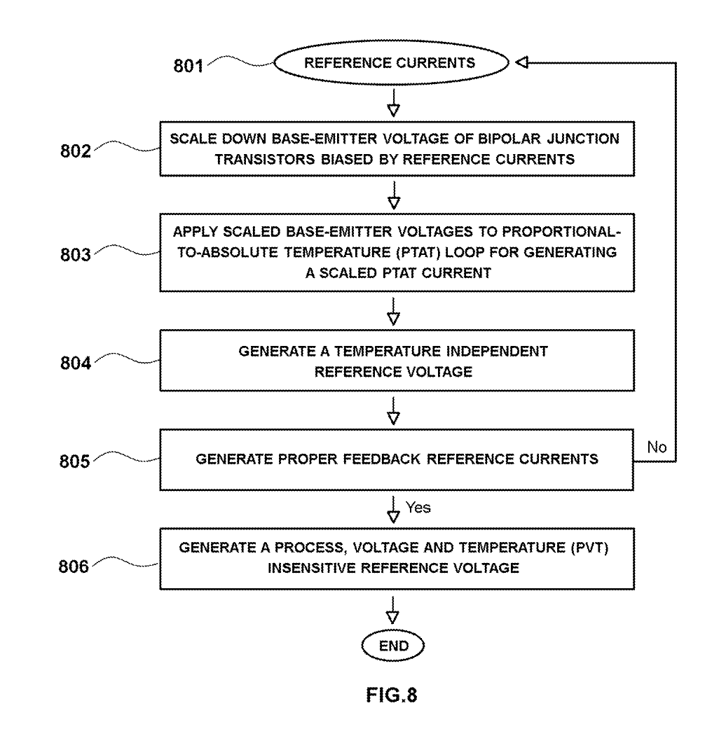

Referring to FIG. 8, a low supply voltage bandgap reference can be provided by a process embodiment of the present invention. The process begins with supplying reference currents (801); then scaling down of bipolar junction transistors biased by the reference currents (802); then applying the scaled base-emitter voltages to a PTAT loop for generating a scaled PTAT current (803); then generating a temperature independent reference voltage (804); then generating proper feedback reference currents (805) and feedback to the reference currents if it has not yet been done; and lastly generating a PVT insensitive reference voltage (806).

The foregoing description of the present invention has been provided for the purposes of illustration and description. It is not intended to be exhaustive or to limit the invention to the precise forms disclosed. Many modifications and variations will be apparent to the practitioner skilled in the art.

While the invention has been described with respect to various exemplary features and advantages, it will be appreciated that the present invention is not limited to such features and that numerous other variations, alternatives, and modifications can be made without departed from the scope and spirit of the appended claims.

What is claimed is:

1. A voltage reference circuit for generating a reference voltage, comprising:
a voltage-to-current converter circuit configured to generate a first reference current and a second reference current;
a first differential voltage divider configured to scale down a first base-emitter voltage of a first bipolar junction transistor biased by the first reference current to generate a first scaled base-emitter voltage;
a second differential voltage divider configured to scale down a second base-emitter voltage of a second bipolar junction transistor biased by the second reference current to generate a second scaled base-emitter voltage; and
a bandgap voltage reference circuit configured to generate a reference voltage by using the first scaled base-emitter voltage and the second scaled base-emitter voltage.

2. The voltage reference circuit of claim 1, wherein the voltage-to-current converter uses the reference voltage to generate the first reference current and the second reference current.

3. The voltage reference circuit of claim 1, wherein the first reference current and the second reference current are constant and equivalent.

4. The voltage reference circuit of claim 1, wherein the first differential voltage divider and the second differential voltage divider each comprises a substantial matching resistor pair with a scalar of divider ratio;

5. The voltage reference circuit of claim 1, wherein size of the second bipolar junction transistor is of multiple of size of the first bipolar junction transistor.

6. The voltage reference circuit of claim 1, wherein the bandgap voltage reference circuit comprises:
an amplifier configured as a voltage damper to generate a scaled proportional-to-absolute-temperature (PTAT) current;
a current buffer to supply the scaled PTAT current across a first feedback resistor and a second feedback resistor; and
a summing circuit to add the first scaled base-emitter voltage into the scaled PTAT current multiplied by sum of a first equivalent resistance of the first differential voltage divider and the first feedback resistor, and the second scaled base-emitter voltage into the scaled PTAT current multiplied by sum of a second equivalent resistance of the second differential voltage divider and the second feedback resistor, respectively.

7. A method for generating a reference voltage, comprising:
scaling down base-emitter voltages of bipolar junction transistors biased by reference currents;
applying the scaled base-emitter voltages to a proportional-to-absolute-temperature (PTAT) loop for generating a scaled PTAT current;
generating a temperature independent reference voltage from the scaled PTAT current;
generating feedback reference currents until all bipolar junction transistors are properly biased over operating temperature range, supply voltage range and process corners; and
generating a process, voltage, and temperature (PVT) insensitive reference voltage from the scaled PTAT current.

8. The method according to claim 7, wherein the feedback reference currents are generated by converting the temperature independent reference voltage.

9. The method according to claim 7, wherein the scaled PTAT current is proportional to difference between the scaled base-emitter voltage of the bipolar junction transistors that is approximately linearly proportional to temperature.

10. The method according to claim 7, wherein non-ideal effects of the feedback reference currents are substantially suppressed by a current ratio within a natural logarithm term.
